(19) United States
(12) Patent Application Publication
(10) Pub. No.: US 2009/0273613 A1
(43) Pub. Date: Nov. 5, 2009

(54) Method and Apparatus for Presentation of Mosaic Theme

(75) Inventors: Monish Subherwal, San Diego, CA (US); Steven Friedlander, San Diego, CA (US); Sabrina Yeh, Laguna Beach, CA (US); Travis Baurmann, San Diego, CA (US); John Salisbury, Carlsbad, CA (US); Yuko Nishikawa, La Jolla, CA (US); Tracy Ho, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS INC., Park Ridge, NJ (US)

(21) Appl. No.: 12/112,262

(22) Filed: Apr. 30, 2008

(51) Int. Cl. G09G 5/00; G06T 15/70

(52) U.S. Cl. 345/634; 345/473

(57) ABSTRACT

The present invention pertains to a method and apparatus for the display of an animated mosaic theme utilizing user images or video. In one embodiment, the method may include electing a mosaic template that includes a plurality of tile regions. The method may also include loading a source image from a memory. Furthermore, the method may include displaying a plurality of regions of the source image that correspond to the plurality of tile regions of the selected mosaic template to display a source image mosaic.

### FIELD OF THE INVENTION

The present invention relates to the field of ambient themes displayed on a television; more particularly, the present invention relates to the display of an animated mosaic theme utilizing images or live video.

### BACKGROUND OF THE INVENTION

Digital display devices such as televisions, computer monitors, cellular telephone displays, etc. are utilized in virtually every facet of modern Life Care is often given to the presentation and quality of the display during the time where a user is actively viewing the display device. However, not much attention is given to displays when a user is not actively viewing the device. For example, a television merely displays a current channel even when not being actively viewed. There remains a need for a beautiful, ambient, and visually entertaining experience that can be displayed on a display device, whether or not he display device is actively being viewed by a user.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a system in which embodiments of the present invention may operate.

FIG. 2 is a block diagram of one embodiment of an ambient mosaic player engine.

FIG. 3 illustrates one embodiment of the generation and display of a mosaic from an image.

FIG. 4A is a flow diagram of one embodiment of a process for entering a mosaic player and displaying a mosaic.

FIG. 4B is a flow diagram of one embodiment of a process for exiting a mosaic player.

FIG. 5 is a flow diagram of one embodiment of a process for creating and refreshing a mosaic.

FIG. 6 is a flow diagram of one embodiment of a process for locating image data for a mosaic.

FIG. 7 is a flow diagram of one embodiment of a process for assembling a mosaic from an image or video.

FIG. 8A illustrates an exemplary representation of a mosaic templates populated with image/video data.

FIG. 8B illustrates an exemplary representation of a mosaic templates populated with image/video data.

FIG. 8C illustrates an exemplary representation of a mosaic templates populated with image/video data.

FIG. 8D illustrates an exemplary representation of a mosaic templates populated with image/video data.

### DETAILED DESCRIPTION OF THE PRESENT INVENTION

A method and apparatus for presentation of a mosaic theme utilizing user images or video. In one embodiment, a mosaic template is selected that includes a plurality of tile regions, which form a visually interesting design or pattern. A source image is loaded from memory and a plurality of regions of the source image are displayed. The source image regions correspond to the plurality of tile regions of the mosaic template, thereby revealing a mosaic design of the source image. In one embodiment, the display the source image regions is accompanied by an animation effect applied to each source image region as that source image region is displayed.

In order to transform an image into a mosaic image, tile regions are selected, randomly and/or sequentially, form the plurality of tile regions that make up a mosaic template. Then certain pixels of the image are mapped to the corresponding tile regions, so that the image tile regions can be displayed with the animation effect. The process continues until all image tile regions are displayed, thereby revealing the image in the form of the mosaic template.

After waiting a predetermined period of time after the final image mosaic has been displayed, in one embodiment the display of the source image mosaic is cleared. A different mosaic template may then be selected in order to construct, animate, and display a new image mosaic.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

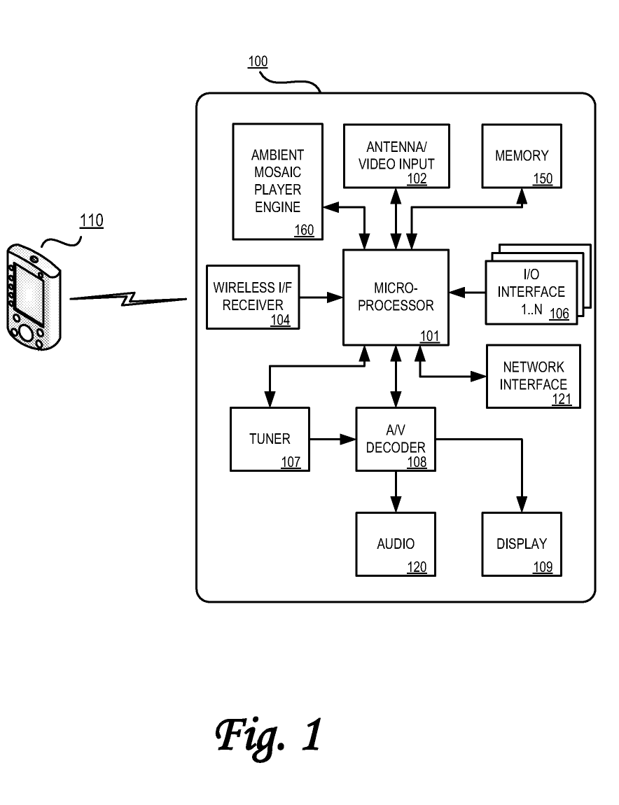

FIG. 1 illustrates one embodiment of a system in which embodiments of the present invention may operate. In one embodiment, mosaics are created and displayed by television 100. In order to avoid obscuring the present invention, the description will refer to the display and creation of mosaics on television 100, although many digital displays, such as cellular telephone displays, personal digital assistant displays, computer monitors, etc. may practice the invention as discussed herein.

Television 100 includes a tuner 107 for receiving cable or broadcast television signals received by antenna/video input 102. The signals are decoded by audio-visual (A/V) decoder 108. Once a television signal is decoded into audio and visual channels by A/V decoder 108, the audio channel is amplified and sent to speakers (e.g., audio unit 120), and the video channel is sent to display 109 (e.g., an LCD, Plasma, Cathode Ray Tube, etc. display). Microprocessor 101 controls both tuner 107 and A/V decoder 108. Thus, the audio and video from the received television signals may then be presented to a user via audio output 120 and display 109.

In one embodiment, a wireless infrared receiver 104 receives IR commands from remote control 110. Other types of remote controls, such as radio frequency remote controls, may also be utilized by television 100. The received commands are then forwarded to microprocessor 101 so that they may be appropriately processed by television 100. Such commands may include channel up/down, volume up/down, key inputs, ambient player entry commands, ambient player exit commands, user preferences, etc.

In one embodiment television further includes a network interface 121, such as an Ethernet interface, broadband modem interface, digital signal line interface, cable modem interface, etc.

In one embodiment, for ambient player services, microprocessor 101 receives user commands from remote control 110 to enter or exit an ambient player, as discussed in greater detail below. Upon receiving commands to enter or exit an ambient player, microprocessor 101 forwards the commands to ambient mosaic player engine 160.

In one embodiment, ambient mosaic player engine 160 enables the creation and display of mosaic designs by fetching live video from either from antenna 102 or tuner 107. In one embodiment, ambient mosaic player engine 160 fetches digital images or video from a data storage devices (not shown) coupled with input/output interfaces 1 . . . N 106. Such data storage devices may include one or more of universal serial bus (USB) storage devices, flash memory devices, SONY® Digital Media (DM) Port storage devices, High Definition Multimedia Interface (HDMI) devices, etc. in the event that ambient mosaic player engine 160 is unable to find suitable media content from a storage device coupled with television 100, in one embodiment, ambient mosaic player engine 160 fetches images or videos that have been pre-stored in memory 150. Because images and/or video are pre-stored by television 100, in one embodiment, ambient mosaic player engine constructs and displays mosaics even if television 100 is not receiving video signals at antenna 102 or tuner 107, or there are no media storage devices coupled with television 100. Furthermore, if an error occurs in fetching media content, ambient mosaic player engine 160 may seamlessly, and with minimal or no user interaction, fetch pre-stored media so that a user experience is not interrupted. The media content, i.e., live video or digital images, are then utilized in the creation and display of mosaics, as discussed herein.

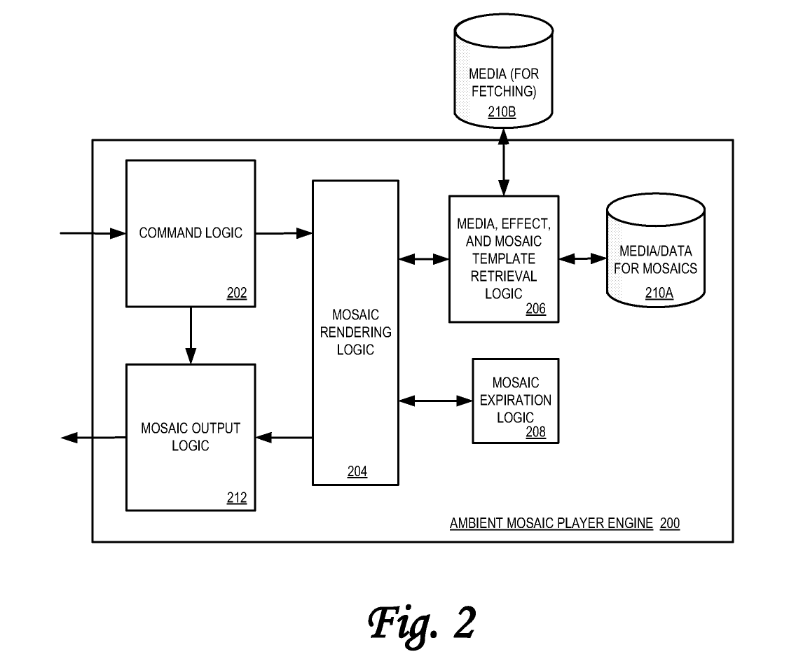

FIG. 2 is a block diagram of one embodiment of an ambient mosaic player engine 200. The ambient mosaic player engine 200 may include command logic 202, mosaic rendering logic 204, media, effect, and mosaic template retrieval logic 206, mosaic expiration logic 208, mosaic output logic 212, and data storage 210A and 210B.

The command logic 202 is responsible for receiving user commands to enter or exit the ambient mosaic player engine 200. The user commands in turn invoke the mosaic rendering logic 204 as well as the mosaic output logic 212. In one embodiment, receipt of an entry command by command logic 202 instructs the mosaic rendering logic 204 to construct and display a mosaic. Furthermore, receipt of an exit command interrupts the mosaic rendering logic and halts any processes currently being performed by the mosaic rendering logic 204, and further instructs the mosaic output logic 212 to stop and clear the display of a mosaic.

Mosaic rendering logic 204 is responsible for the creation and the display of a mosaic image or mosaic video. In one embodiment, mosaic rendering logic 204 instructs media, effect, and mosaic template retrieval logic 206 to fetch and load a video/image, an effect to be applied to the mosaic as the mosaic is rendered and displayed, and a mosaic template. In one embodiment, media, effect, and mosaic template retrieval logic 206 fetches the content randomly. Thus, where here are C content items (i.e., video and images), E effects, and M mosaic templates, mosaic rendering logic 204 is enabled to render and display a total of C×E×M different mosaics.

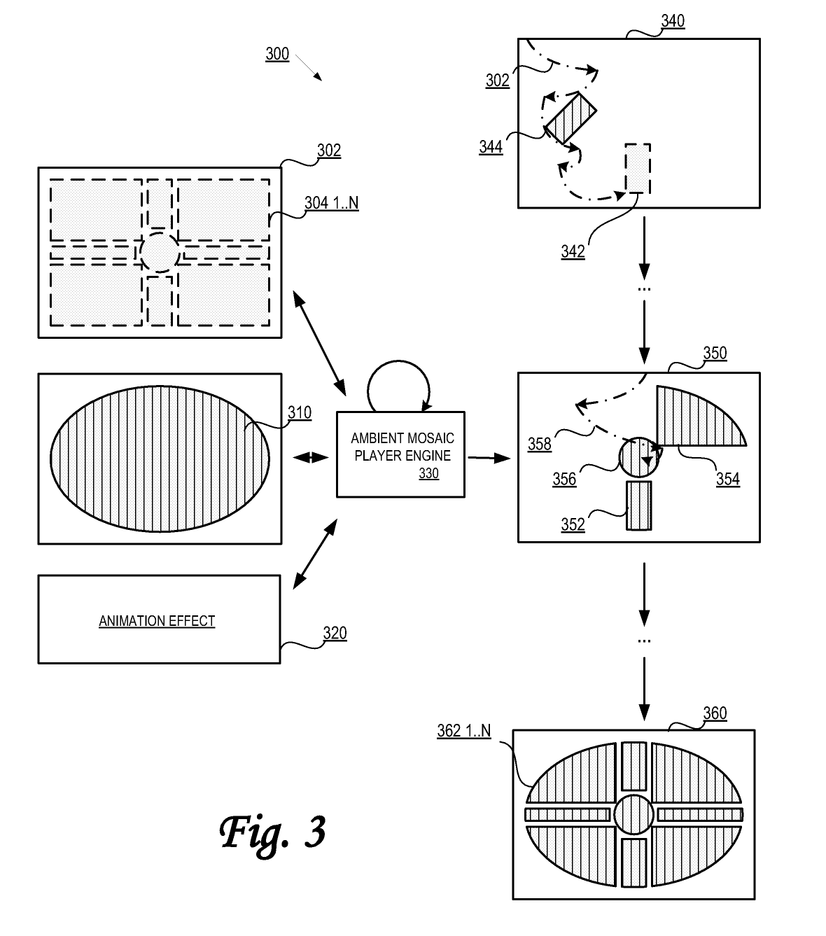

In one embodiment based on the selected mosaic template, the selected effect, and the selected media content, mosaic rendering logic creates the mosaic. As will be discussed and illustrated below in FIG. 3, in one embodiment, each mosaic template consists of a number of tile regions, where each tile region of the mosaic template is mapped to a corresponding region of the selected media content item. Then, the media content regions, corresponding to the tile regions, are individually selected and displayed with the animation effect. The display of the individual media content regions continues until all of the tile regions have been displayed, revealing the media content item in the form of the mosaic template. Thus, an ambient, beautiful, and entertaining visual experience is created and displayed on the television.

Mosaic expiration logic 208 is responsible for ending the display of a completed mosaic image. In one embodiment, mosaic expiration logic 208 receives an indication from mosaic rendering logic 204 that a mosaic has been fully constructed. Mosaic expiration logic waits a predetermined period of time (e.g., two second, five second, ten seconds, etc.) until instructing mosaic rendering logic 204 to begin construction of a new mosaic, as well as to instruct mosaic output logic 212 to clear the display of the completed mosaic.

Mosaic output logic 212 is responsible for receiving mosaic image tiles, completed mosaics, etc. and displaying the items on a television. In one embodiment, mosaic output logic 212 forwards the rending and display data to an audio/video decoder for display. In one embodiment, mosaic output logic 212 acts as a decoder and displays the tiles, completed mosaics, etc. on a display device.

FIG. 3 illustrates one embodiment of the generation and display of a mosaic from an image. As discussed above, and as will be discussed below in greater detail, an ambient mosaic player engine 330, fetches a mosaic template 302 that consists of a plurality of tile regions 304 1 . . . N. The ambient mosaic player engine 330 further fetches, in this example, a source image 310. The ambient mosaic player engine 330 also fetches an animation effect 320. Each of the mosaic template 302, source image 310, and animation effect 320 may be selected at random, according to a predefined sequence, based on user preferences, etc.

In one embodiment, ambient mosaic player engine 330 maps the regions of the template, defined by the tile regions, to corresponding regions of source image 310.

Each region of the image 310 may then be displayed individually and/or sequentially at a display device based on the animation effect 320. As illustrated, a first tile region of the source image 344 is displayed on a display device 340 utilizing animation effect 346. As show, the path of animation effect 346 is illustrated by the dashed line, and the source image tile region 344 is rendered along the animation path until the tile region of the source image 344 is displayed at the tile region 342 defined by the mosaic template 302.

Ambient mosaic player engine 330 continues to select and render tiles of the source image on display 340. As illustrated in the updated display 350, tile regions 352 and 354 of the source image have finished animation and are displayed in their final positions based on the mosaic template. Source image tile region 356 has finished animation 358 and has arrived at the corresponding tile region defined by the mosaic template 302.

Ambient mosaic player engine 330 continues to select and render tiles of the source image on the display until all source image tile regions 362 1 . . . N are displayed. The resulting display of source image tiles 362 1 . . . N is the animation and display of image 310 subject to template 302, in a visually interesting and pleasing fashion.

As illustrated in FIG. 3, a “Leaf” animation effect was applied to the individual tile regions of the source image. That is, the tile regions are rendered and animated to appear as if they are falling in a zigzag patter as would appear if a leaf were falling from a tree. Other animation patters such as a vertical up or vertical down animation may be applied to each tile regions. Other similar animation patters could likewise be applied to the source image tile regions. Further, in one embodiment, each tile region of the source image is animated according to a different animation effect.

In one embodiment, the animation effect need not be movement of source image tile regions across a display device. Rather, in one embodiment, a source image tile region is displayed in the corresponding template tile region, but the a channel value (i.e., a data value associated with image data, such as complete pictures, pixels, etc., that defines the opacity of that image data) for the source image tile regions is adjusted as the animation effect. Thus, in one embodiment, the a channel is adjusted from 0% to 120%, and back to 100% so that the tile regions are displayed from translucent to opaque. Each of the tile regions appears to “Pop” on a display in the corresponding regions of the mosaic template.

Further, in one embodiment, each tile region may be obstructed, either fully or partially, by a mask, graphic, etc. displayed over each source image tile. The mask, graphic, etc. is then animated to reveal the source image tiles, either by animating the movement of the mask off of the source image tiles, or by adjusting the α channel of the mask image from opaque to translucent. Thus, the “Mask” is animated to reveal the underlying source image tile contents.

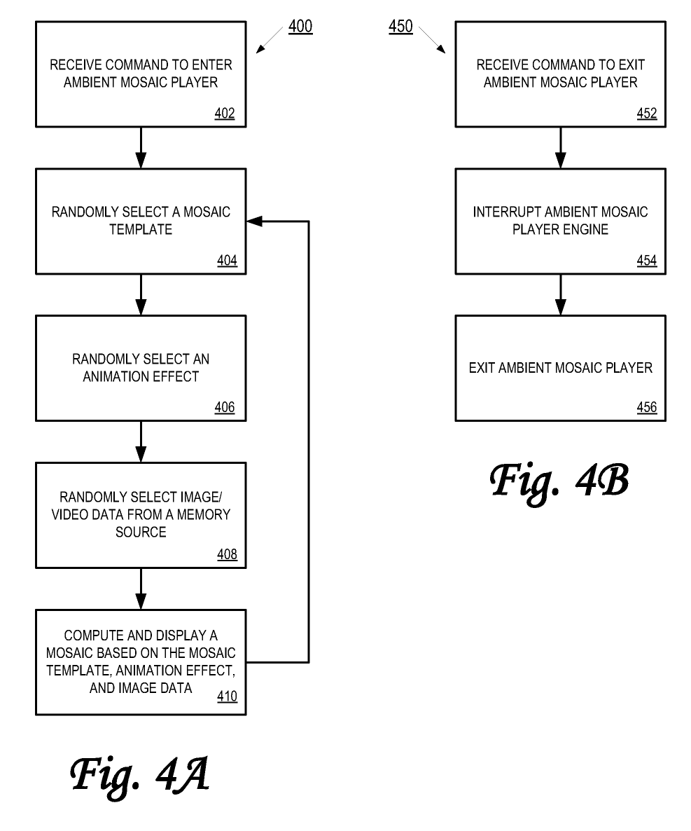

FIG. 4A is a flow diagram of one embodiment of a process 400 for entering a mosaic player and displaying a mosaic. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in an ambient mosaic player engine as illustrated and discussed in of FIGS. 2 and 3.

Referring to FIG. 4A, process 400 begins with processing logic receiving a command to enter an ambient mosaic player (processing block 402). In one embodiment, the command may be received as signals from a remote control. Such remote control commands may includes receiving a <favorites> command, receiving a command from within an option menu displayed on a television, receiving a command from a dedicated button of a remote control, etc.

In response to receiving the command to enter the ambient mosaic player, a mosaic template is randomly selected (processing block 404). In one embodiment, the mosaic templates are selected from a plurality of mosaic templates stored internally by the ambient mosaic player, stored in external memory, or a combination of both. Processing logic further randomly selects an animation effect from a plurality of different animation effects (processing block 406).

Processing logic also selects, at random, image or video data from a memory source (processing block 408). In one embodiment, the memory source may include images/videos that are stored in a USB memory device or flash storage device coupled with a television. Furthermore, the memory source may also be obtained from an HDMI, composite cable (i.e., a broadcast or cable television signal a digital video disk signal, etc.), or Digital Living Alliance (DLNA) standards compliant interfaces. In the case of HDMI, composite cable, or DLNA interface, processing logic selects and obtains live video content.

Processing logic then computes and displays a mosaic based on the selected mosaic template, animation effect, and image data (processing block 410). After a brief period, in which the completed mosaic is displayed, processing logic returns to processing block 404 to select, construct, and display a new mosaic.

FIG. 4B is a flow diagram of one embodiment of a process 450 for exiting a mosaic player. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in an ambient mosaic player engine as illustrated and discussed in of FIGS. 2 and 3.

Referring to FIG. 4B, process 450 begins with processing logic receiving a command to exit an ambient mosaic player (processing block 452).

In one embodiment, the command to exit the mosaic player is received when processing logic detects receipt of a <return> signal from a remote control (i.e., receiving a command from a user to return to a previous menu option, return to a previously viewed channel, etc.). In one embodiment, an internal error of an ambient mosaic player is also interpreted by processing logic as a command to exit the ambient player.

In response to receiving a command to exit the ambient player, processing logic interrupts the processes of the ambient mosaic player engine (processing block 454), and exits the ambient player (processing block 456). In one embodiment, processing logic issues a global interrupt command to the ambient mosaic player engine which halts whatever processes (i.e., mosaic template selection, source image tile animation, mosaic template to image tile mapping, etc.) are currently being processed by the ambient mosaic player engine.

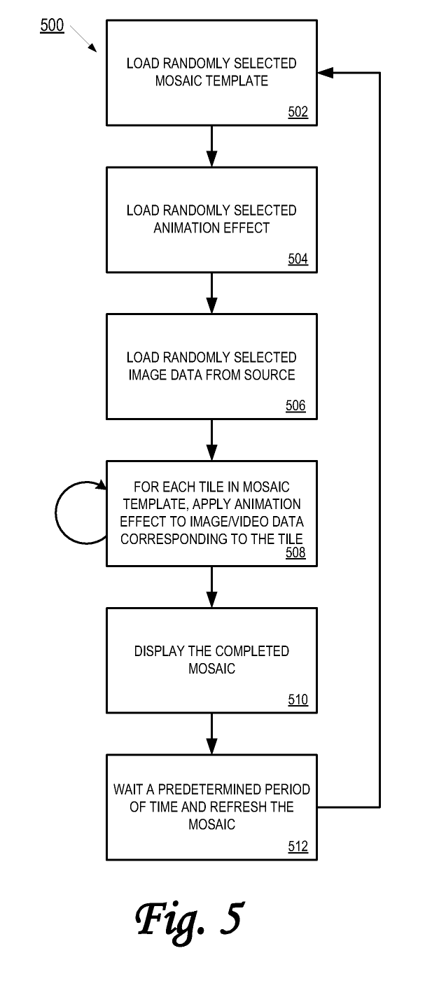

FIG. 5 is a flow diagram of one embodiment of a process for creating and refreshing a mosaic 500. The process may be performed by processing logic that may comprise hardware (e.g., dedicated logic, programmable logic, microcode, etc.), software (such as run on a general purpose computer system or a dedicated machine), or a combination of both. In one embodiment processing logic resides in an ambient player mosaic engine as illustrated and discussed in of FIGS. 2 and 3.

Referring to FIG. 5, process 500 begins with processing logic loading a randomly selected mosaic template, loading a randomly selected animation effect, and loading a randomly selected image/video from a source (processing blocks 502-506). In one embodiment, the template, animation effect, and image/video are loaded into an ambient mosaic player engine.

For each tile in the mosaic template, processing logic applies the selected animation effect to the image/video data corresponding to the region defined by the tile (processing block 508). After each tile has been animated, processing logic displays the completed mosaic (processing block 510). In one embodiment, processing logic animates each tile region of the source image/video until the tile is displayed in the appropriate location based on the corresponding region of the mosaic template. This continues until all source image tiles have been displayed, which reveals the source image in the form of the mosaic design.

Processing logic waits a predetermined period of time and refreshes the mosaic (processing block 512). That is, processing logic waits until the mosaic display has expired before clearing the mosaic and returning to processing block 502 in order to display a new mosaic.

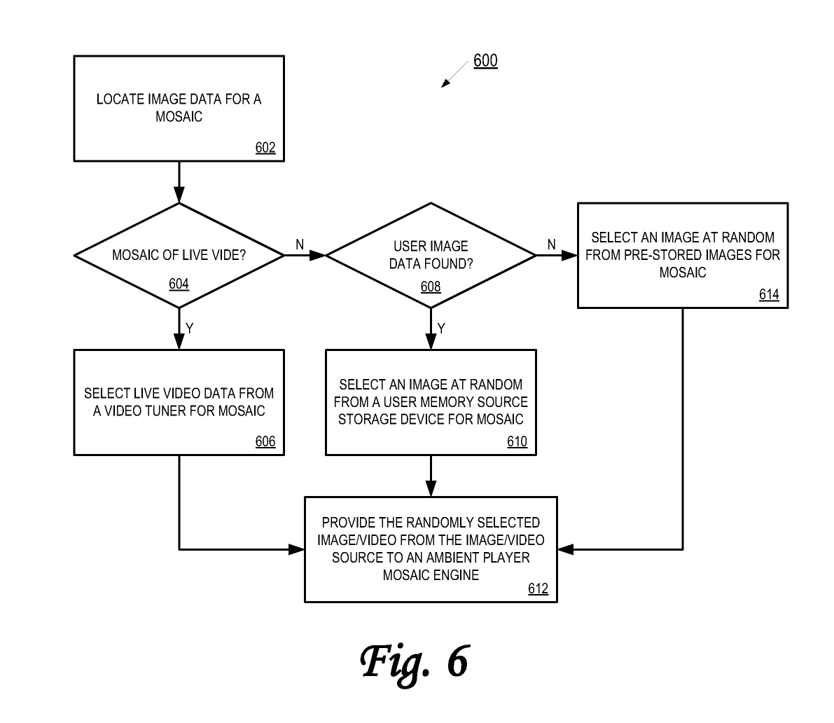

FIG. 6 is a flow diagram of one embodiment of a process for locating image data for a mosaic 600. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in an ambient mosaic player engine as illustrated and discussed in of FIGS. 2 and 3.

Referring to FIG. 6, process 600 begins with processing logic locating image data for a mosaic (processing blocks 502-506). In one embodiment, processing logic fetches image/video content during the construction and display of a mosaic, as discussed above with respect to FIGS. 3-5.

Because mosaics may be created for either video data or image data, processing logic determines if the mosaic to be created is a mosaic of live video (processing block 604). In one embodiment, a user preference may determine the mosaic to be created is a live video mosaic. When the image data to be located is for live video, processing logic selects live video data from a video tuner or antenna for the mosaic (processing block 606). In one embodiment, processing logic selects video from a television channel that the tuner is currently tuned to. The video data from the tuner is then provided to an ambient player mosaic engine (processing block 612), for construction and display of a mosaic.

When a mosaic is not a mosaic of live video, processing logic determines if there is user image and/or video data to fetch (processing block 608). In one embodiment, processing logic queries interface ports of a television, such as input/output interfaces 1 . . . N 106 of FIG. 1, to determine if a media storage device (i.e., USB device, flash memory device, etc.) is coupled with the input/output interface and whether image or video data is available on the storage device. If it is determined that user image/video data is available, processing logic selects an image/video at random from the user memory source for the mosaic (processing block 610). The randomly selected user media content is then provided to the ambient player mosaic engine to enable the mosaic engine to create a user content based mosaic (processing block 612).

When user image/video data, as well as live video, is not available or not selected for a current mosaic, processing logic fetches an image at random from a plurality of pre-stored images for the mosaic (processing block 614) and provides the image/video to an ambient mosaic player engine (processing block 612). In one embodiment, the availability of user content may be due to the absence of a memory source for media data, problems with image content, or non-supported image/video types. Furthermore, because processing logic is enabled to fetch image data for pre-stored images, error messages and user interactions are minimized when fetching media content for mosaic creation. That is, processing logic provides a passive user experience that is able to revert to built-in images or video, instead of exiting an ambient player or interrupting the ambient player to display an error message.

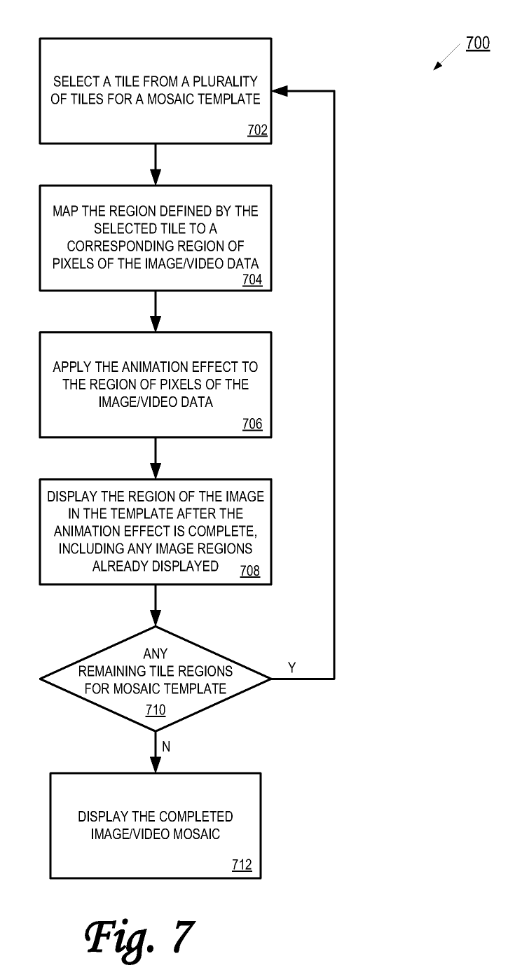

FIG. 7 is a flow diagram of one embodiment of a process for assembling a mosaic from an image or video 700. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in an ambient player mosaic engine as illustrated and discussed in of FIGS. 2 and 3. Note that it is assumed that a processing logic, as discussed above, has already selected a mosaic template, animation effect, and video or image source.

Referring to FIG. 7, process 700 begins with processing logic selecting a tile from a plurality of tiles for a mosaic template (processing block 702). In one embodiment, the tile is selected at random from among the plurality of tiles. However, the tile may also be selected based upon a selection pattern associated with the particular mosaic template, or a generalized tile selection process common to all mosaic templates.

Processing logic them maps the region defined by the selected tile to a corresponding region of pixels of the image or video data (processing block 704). In one embodiment, bitmap images are utilized because the bitmap images provide an array of pixels, along with image and location data for each pixel, in an easily obtainable form. However, formats of images/videos may be utilized that contain location data for pixels or regions of the image, or formats where such data may be obtained. From the location data for the pixels of image/video data, the region of the image, corresponding to the mosaic tile, may be extracted from the image and processed by processing logic.

The animation effect is then applied to the region of pixels extracted from the image/video data based on the mapping results (processing block 706). In one embodiment, the animation effect, which was randomly selected, applies an animation effect such as the Leaf, Pop, Mask, etc. effects described above. The region of the image, which corresponds to a mosaic template region is then displayed after completion of the animation effect, along with image regions that have already been animated/displayed (processing block 708).

Processing logic determines whether there are any remaining tile regions for the mosaic template that have not be “filled in” by image or video data (processing block 710). That is, processing logic determines, based on the mosaic template and the plurality of tiles that make up the mosaic template pattern, whether any of the mosaic template tile regions have not been populated with image data. When processing logic determines that not all tile regions have been displayed, processing logic returns to processing block 702 to select another tile from the remaining tiles for the mosaic template.

After all tile regions for the mosaic template have been filled with image or video regions, processing logic displays the completed image/video mosaic (processing block 712).

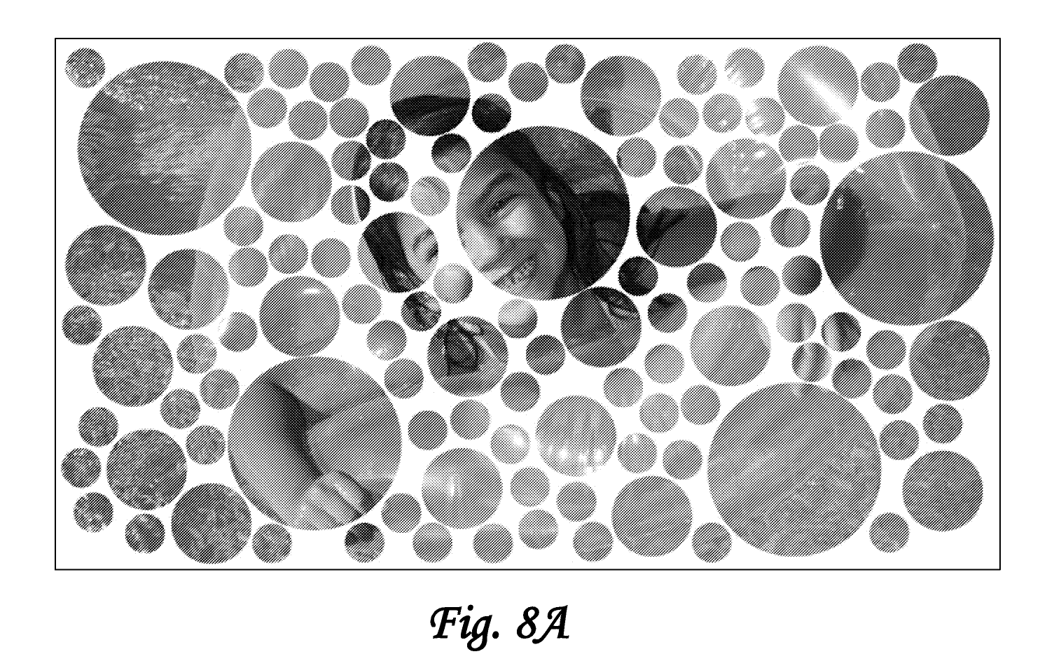

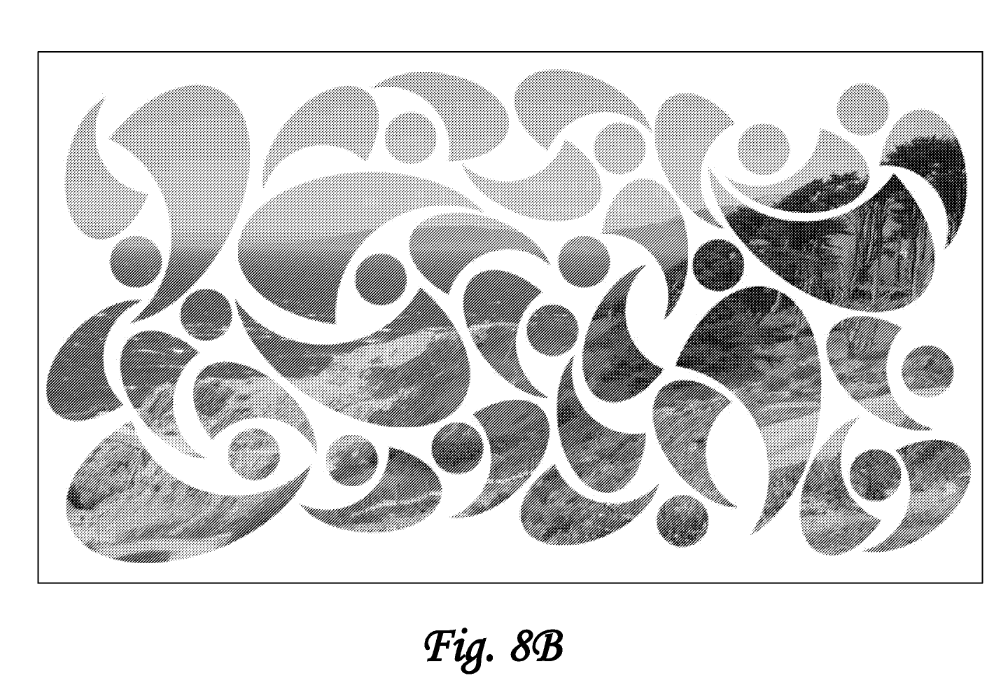

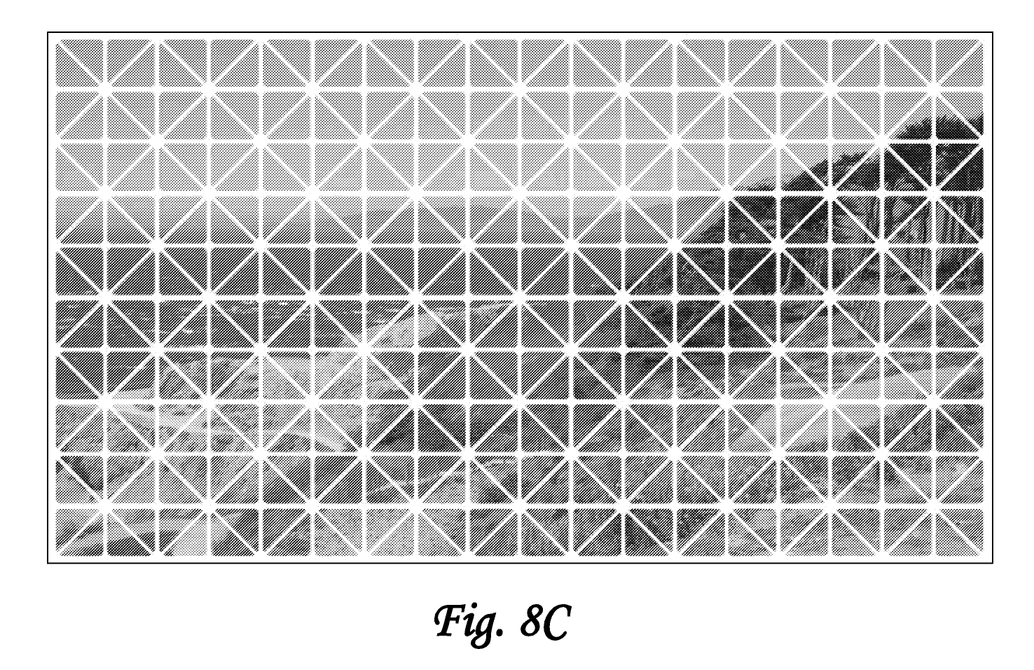

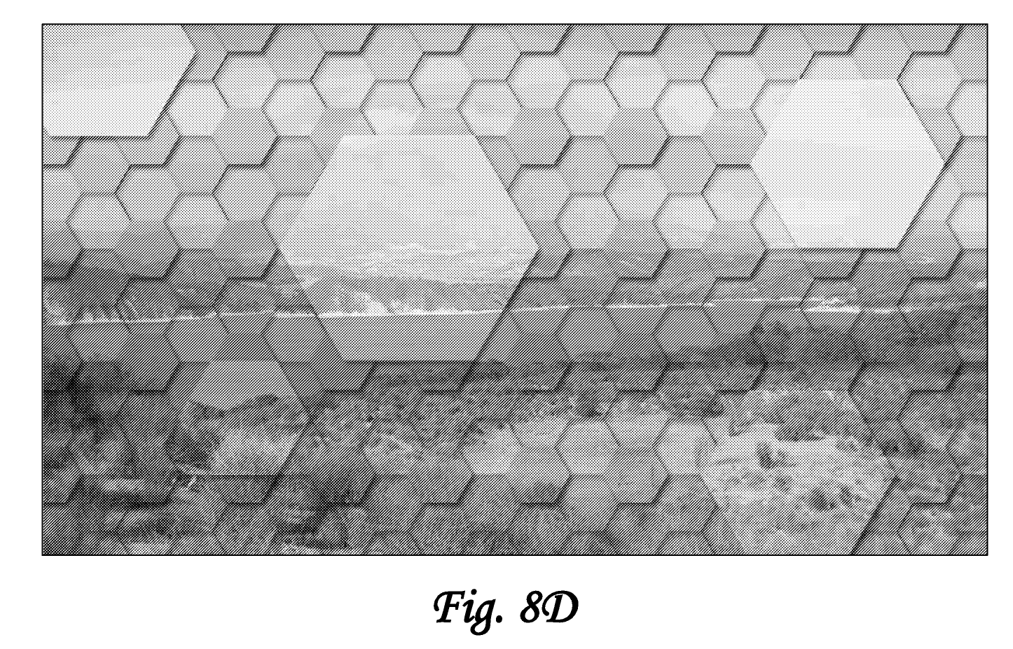

FIGS. 8A-8D show exemplary representations of various mosaic templates, which are populated with image/video data. As discussed above, each mosaic template includes a plurality of tile regions. Image or video data is rendered to populate the tile regions of the mosaic template based on the image/video, mosaic template design, and an animation effect.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method, comprising:
selecting a mosaic template that includes a plurality of tile regions;
loading a source image from a memory; and
displaying a plurality of regions of the source image that correspond to the plurality of tile regions of the selected mosaic template to display a source image mosaic.

2. The method of claim 1, wherein the displaying further comprises:
displaying the plurality of regions of the source image data with an animation effect applied to each of the plurality of regions of the source image as the regions of the source image are displayed.

3. The method of claim 2, further comprising:
selecting a first tile that defines a first tile region from the plurality of tile regions of the mosaic template;
mapping the selected first tile region of the mosaic template to a corresponding region of pixels from the source image data on the selected first tile, to obtain a first tile image data;
displaying the first tile image data with the animation effect; and
when there is at least one tile region from the plurality of tile regions that has not been displayed, selecting, mapping, and displaying individual tile regions from the at least one tile regions until all tile regions of the mosaic have been displayed.

4. The method of claim 3, wherein the animation effect is randomly selected from a plurality of animation effects, the loaded source image data is randomly selected from a plurality source images, and the mosaic pattern is randomly selected from a plurality of mosaic patterns.

5. The method of claim 1, wherein the plurality of tile regions of the mosaic template define pixel regions where source image data corresponding to the pixel regions will be visible when the source image mosaic is displayed.

6. The method of claim 1, further comprising:
waiting a predetermined period of time after the source image mosaic has been displayed;
clearing the display of the source image mosaic; and
selecting a different mosaic template from a plurality of mosaic template.

7. The method of claim 1, wherein the source image mosaic is displayed on a television.

8. The method of claim 7, wherein the source image is live video obtained from a tuner of the television.

9. The method of claim 7, wherein the source image is an image file loaded from internal memory of the television.

10. The method of claim 7, wherein the source image is an image file loaded from a data storage device coupled to the television.

11. A computer readable medium that provides instructions, which when executed on a processing system, cause said processing system to perform a method comprising:
selecting a mosaic template that includes a plurality of tile regions;
loading a source image from a memory; and
displaying a plurality of regions of the source image that correspond to the plurality of tile regions of the selected mosaic template to display a source image mosaic.

12. The method of claim 11, wherein the displaying further comprises:
displaying the plurality of regions of the source image data with an animation effect applied to each of the plurality of regions of the source image as the regions of the source image are displayed.

13. The method of claim 12, further comprising:
selecting a first tile that defines a first tile region from the plurality of tile regions of the mosaic template;
mapping the selected first tile region of the mosaic template to a corresponding region of pixels from the source image based on the selected first tile, to obtain a first tile image data;
displaying the first tile image data with the animation effect; and
when there is at least one tile region from the plurality of tile regions that has not been displayed, selecting, mapping, and displaying individual tile regions from the at least one tile regions until all tile regions of the mosaic have been displayed.

14. The method of claim 13, wherein the animation effect is randomly selected from a plurality of animation effects, the loaded source image data is randomly selected from a plurality source images, and the mosaic pattern is randomly selected from a plurality of mosaic patterns.

15. The method of claim 11, wherein the plurality of tile regions of the mosaic template define pixel regions where source image data corresponding to the pixel regions will be visible when the source image mosaic is displayed.

16. The method of claim 11, further comprising:
waiting a predetermined period of time after the source image mosaic has been displayed;
clearing the display of the source image mosaic; and
selecting a different mosaic template from a plurality of mosaic templates.

17. A system comprising:
a display;
a processor; and
an ambient mosaic player engine coupled with the display and the processor to,
select a mosaic template that includes a plurality of tile regions responsive to a user command to display a mosaic on the display,
load a source image from a source coupled with the system, and
render a source image mosaic of a plurality of regions of the source image that correspond to the plurality of tile regions of the selected mosaic template on the display.

18. The system of claim 17, wherein the ambient mosaic player engine is to display the plurality of regions of the source image data with an animation effect applied to each of the plurality of regions of the source image as the regions of the source image are rendered.

19. The system of claim 18, wherein the ambient mosaic player engine is to select a first tile that defines a first tile region from the plurality of tile regions of the mosaic template, map the selected first tile region of the mosaic template to a corresponding region of pixels from the source image based on the selected first tile, to obtain a first tile image data, render the first tile image data with the animation effect on the display, and select, map, and display individual tile regions from the at least one tile regions until all tile regions of the mosaic have been rendered on the display when there is at least one tile region from the plurality of tile regions that has not been rendered.

20. The system of claim 19, wherein the animation effect is randomly selected from a plurality of animation effects, the loaded source image data is randomly selected from a plurality source images, and the mosaic pattern is randomly selected from a plurality of mosaic patterns.

21. The system of claim 17, further comprising:
a television tuner coupled with the display and the ambient mosaic player engine to provide live video as a first source for the source image to the ambient mosaic player engine;
a memory coupled with the ambient mosaic player engine to store a plurality of digital images and provide the plurality of digital images as a second source for the source images to the ambient mosaic player engine; and
an input/output interface coupled with the ambient mosaic player engine to provide a third source for the source image from one of a plurality of data storage devices selectively coupled with the input/output interface.
